(19) United States
(12) Patent Application Publication
(10) Pub. No.: US 2025/0232403 A1
(43) Pub. Date: Jul. 17, 2025

(54) METHOD FOR DETECTING INSULATOR FAULT OF TRANSMISSION LINE BASED ON USRNet AND IMPROVED MobileNet-SSD ALGORITHM

(71) Applicant: CHONGQING UNIVERSITY, Chongqing (CN)

(72) Inventors: Xu TAN, Chongqing (CN); Zhimin LI, Chongqing (CN); Fan YANG, Chongqing (CN); Zikang YANG, Chongqing (CN); Jinqiao DU, Chongqing (CN)

(73) Assignee: CHONGQING UNIVERSITY, Chongqing (CN)

(21) Appl. No.: 18/700,394

(22) PCT Filed: Jun. 29, 2023
(86) PCT No.: PCT/CN2023/103527

§ 371 Date: Apr. 11, 2024

(30) Foreign Application Priority Data
Mar. 7, 2023 (CN) 202310218843.8

(51) Int. Cl. G06T 3/4053; G06V 10/22; G06V 10/80; G06V 10/82

(52) U.S. Cl. CPC G06T 3/4053; G06V 10/22; G06V 10/806; G06V 10/82

(57) ABSTRACT

The present disclosure provides a method for detecting an insulator fault of a transmission line based on an unfolding super-resolution network (USRNet) and an improved MobileNet-SSD algorithm, and belongs to the field of assessment on conditions of power equipment. The method includes: performing super-resolution reconstruction on an original image through a USRNet; based on a MobileNet-SSD detection model, performing clustering on a labeled box through K-means++, to generate an anchor box matching a target size of a fault of a transmission line; changing a structure of a multi-scale feature fusion module, and introducing, at a prediction end, six target detection boxes, to detect a small fault target; and optimizing overall performance of the model based on an effective intersection over union function. Based on a constructed improved MobileNet-SSD detection model, insulator recognition, positioning, and fault detection are performed on an optimized image. Therefore, fewer parameters and calculations are required.

### CROSS REFERENCE TO RELATED APPLICATION

This patent application is a national stage application of International Patent Application No. PCT/CN2023/103527, filed on Jun. 29, 2023, which claims the benefit and priority of Chinese Patent Application 202310218843.8 titled “METHOD FOR DETECTING INSULATOR FAULT OF TRANSMISSION LINE BASED ON USRNet AND IMPROVED MobileNet-SSD ALGORITHM” and filed with the China National Intellectual Property Administration on Mar. 7, 2023, the disclosure of which is incorporated by reference herein in its entirety as part of the present application.

### TECHNICAL FIELD

The present disclosure belongs to the field of assessment on conditions of power equipment, and relates to the field of fault detection on an insulator of a transmission line.

### BACKGROUND

An insulator is an important component in a transmission line. The insulator easily has a failure when being exposed to a harsh environment outdoors for a long time, and needs to be regularly inspected by an unmanned aerial vehicle and other means. However, a part of images taken by the unmanned aerial vehicle have an attribute of a large field of view. Targets such as an insulator fault have problems such as a complex background environment and a small defect target. Therefore, there is interference in fault detection on the image. In addition, a current deep learning algorithm has problems such as a large quantity of parameters of a model and high requirements for hardware. For example, a quantity of parameters of a YOLOv5x model is 86.7 million. Due to the large quantity of parameters, calculations are large, and calculation speed is slow. As a result, the current deep learning algorithm is difficult to be embedded in a mobile device with poor hardware. Therefore, there is an urgent need to provide a lightweight method for detecting a small target fault of a transmission line in a complex background, to enable the model to be embedded in mobile devices such as the unmanned aerial vehicle, and improve accuracy and speed of detection.

Problems of a complex background, detection on a small target, and lightweight are key points and difficulties that need to be resolved by a target detection algorithm based on deep learning. Problems that context information on the image is discontinuous or unclear because the target is blurry and the target is under occlusion in the complex background seriously affect effectiveness of target detection.

Further, the small target occupies few pixels in an original image, and carried information is limited. Because of lack of appearance information related to detection, a resolution of a small target is reduced after multiple subsampling, and feature information is gradually weakened. Therefore, detection difficulty is increased.

### SUMMARY

In order to solve the above problems existing in the prior art, the present disclosure provides an experimental platform. A method for detecting an insulator fault of a transmission line based on an unfolding super-resolution network (USRNet) and an improved MobileNet-SSD algorithm is provided. Technical solutions of the present disclosure are as follows:

A method for detecting an insulator fault of a transmission line based on a USRNet and an improved MobileNet-SSD algorithm includes:
performing super-resolution reconstruction on an original image through a deep USRNet, to implement optimization of a test dataset;
based on a MobileNet-SSD detection model, performing clustering on a labeled box through K-means++, to generate an anchor box matching a target size of a fault of a transmission line; and introducing, by changing a structure of a multi-scale feature fusion module, a detection head including a larger feature map at a prediction end, to detect a small fault target; and
optimizing overall performance of the model based on an effective intersection over union (EIOU)_Loss function; and performing, based on a constructed improved MobileNet-SSD detection model, insulator recognition, positioning, and fault detection on an optimized image.

Further, the performing super-resolution reconstruction on an original image through a deep USRNet specifically includes:
modelling a common problem of super-resolution:

$${z}_{k} = arg {min}_{z} {‖ y - ( z ⊗ g ) {↓}_{s} ‖}^{2} + {μσ}^{2} {‖ z - {x}_{k - 1} ‖}^{2} ,$$

$${x}_{k} = arg {min}_{z} \frac{μ}{2} {‖ {z}_{k} - x ‖}^{2} + λϕ ( x ) ,$$

where
x represents a high-resolution image of the transmission line; xₖ represents a high-resolution image of the transmission line when a k^{th} iteration is performed; xₖ₋₁ represents a high-resolution image of the transmission line when a (k−1)^{th} iteration is performed; z represents an auxiliary variable introduced based on a semi-quadratic splitting algorithm; zₖ represents an auxiliary variable introduced based on the semi-quadratic splitting algorithm when the k^{th} iteration is performed; g represents a fuzzy kernel; μ represents a penalty parameter for controlling a difference between z and x; k represents a quantity of iterations, k=1, . . . , 8; arg min represents a value of a subscript variable z when a posterior formula is smallest; s represents a multiple for bicubic subsampling; y represents a low-resolution image of the transmission line; ⊗ represents a symbol of a tensor product; ⬇ represents a subsampling operation; g represents a fuzzy kernel; ϕ(x) represents noise intensity; λ represents a hyperparameter for controlling the noise intensity; σ represents a noise level; and a clearest HR image x₈ of the transmission line may be obtained by solving x and z through iteration performed by a neural network.

Further, the deep USRNet mainly includes three parts.

A first part is data module D, and is used to solve zₖ=arg min_{z}∥y−(z⊗g)⬇ₛ∥²+μσ²∥z−xₖ₋₁∥². The data module D performs fast F(·) and complex conjugate transform F⁻¹(·) through pytorch, introduces a Fourier transform hyperparameter αₖ, and minimizes zₖ:

$${z}_{k} = {F}^{- 1} ( \frac{1}{{α}_{k}} ( d - \overline{F} ( g ) {⊙}_{s} \frac{( F ( g ) d ) {⇓}_{s}}{( \overline{F} ( g ) F ( g ) ) {⇓}_{s} + {α}_{k}} ) ) ,$$

where
F̅(·) represents a conjugate complex of F(·); αₖ represents a hyperparameter; F(g) represents Fourier transform performed on the fuzzy kernel; [symbol] represents a subsampler; ⊙ represents an XNOR operator;

$$d = \overline{F} ( g ) F ( y {↑}_{s} ) + {α}_{k} F ( {x}_{k - 1} ) ,$$

where
⬆ represents an upsampling operation; and

$${α}_{k} = μ k {σ}^{2} ;$$

the solution process is abbreviated as follows:

$${z}_{k} = D ( {x}_{k - 1} , s , g , y , {α}_{k} ) ,$$

where
x₀ is obtained through y by nearest interpolation; and s represents a multiple of subsampling.

A second part is a prior module P, and is used to perform, through a U-shaped network added with a residual term, noise reduction on the original image, to solve

$${x}_{k} = arg {min}_{z} \frac{μ}{2} {‖ {z}_{k} - x ‖}^{2} + λϕ ( x ) ,$$

and the noise level is as follows:

$${β}_{k} = \sqrt{λ / {μ}_{k}} ,$$

where
βₖ represents a noise level when a k^{th} iteration is performed, μₖ represents a penalty parameter for controlling a difference between z and x when the k^{th} iteration is performed, and
the noise reduction process is abbreviated as follows:

$${x}_{k} = P ( {z}_{k} , {β}_{k} ) .$$

A third part is a hyperparameter module H, and is used to calculate αₖ and βₖ required for each iteration:

$$[ α , β ] = H ( σ , s ) .$$

The hyperparameter module includes three fully connected layers, each layer has 64 hidden nodes, an activation function of the first two layers is ReLU, and an activation function of the last layer is Softplus.

Further, the performing clustering on a labeled box through K-means++, to generate an anchor box matching a target size of a fault of a transmission line includes:
(1) randomly taking a target box of a sample as an initial clustering center, where the target box of the sample is the labeled box; and calculating a minimum intersection over union IOU distance A(x′) between a remaining labeled box and a current clustering center:

$$A ( {x}^{′} ) = 1 - {I}_{( {x}^{′} , c )} , {x}^{′} ∈ X ,$$

where
I represents an intersection over union between the target boxes of two samples; x′ represents a labeled box of a sub-target sample, that is, one target box of a total target box, the labeled box of the sample is the labeled box of the target, and when a clustering algorithm is performed on the total target box, each target box is considered to be a sample; and c represents a clustering center;
(2) calculating probability O(x) that a target box of each insulator sample is taken as a next clustering center, and selecting the next clustering center through a roulette wheel method:

$$O ( {x}^{′} ) = \frac{A {( {x}^{′} )}^{2}}{λ ⊂ {\sum }_{{x}^{′} ∈ X} A {( {x}^{′} )}^{2}} ,$$

where
X represents a total sample of the labeled box of the target, that is, the total target box;
(3) repeating step (1) and step (2) until K clustering centers are selected; and
(4) calculating a distance from each sample x′ in the dataset to the K clustering centers, assigning the sample to a category corresponding to a clustering center with a smallest distance, and recalculating a clustering center of each category cₗ, where a formula is as follows; and re-updating classification and the clustering center until the size of the anchor box remains unchanged:

$${c}_{l} = \frac{1}{\vert {c}_{l} \vert} {\sum }_{{x}^{′} ∈ {c}_{l}} {x}^{′} ,$$

where
l=1, . . . , K; K represents a quantity of different sizes of anchor boxes, and a value of K is determined by a quantity of anchor boxes in the MobileNet-SSD detection model.

Further, the constructed improved MobileNet-SSD detection model specifically includes: changing a structure of the MobileNet-SSD of the model, that is, adding eight different scales of convolutional layers after a last convolutional layer of MobileNetV1, where a shallow feature layer is used to detect a small target object, and a deep feature layer is used to detect a large target object; and extracting six different scales of effective feature maps from six of the layers through MobileNet-SSD, and performing multi-scale feature prediction, where resolutions of the effective feature maps are respectively 19*19, 10*10, 5*5, 3*3, 2*2, and 1*1.

Further, the optimizing overall performance of the model based on an EIOU_Loss function specifically includes:
replacing CIOU_Losses of the original model with EIOU_Losses, where penalty terms of EIOU_Losses include an overlap loss L_{IOU}, a center distance loss L_{dis}, and a width-height loss Lₐₛₚ, and a calculation formula is as follows:

$${L}_{EIOU} = {L}_{IOU} + {L}_{dis} + {L}_{asp} = 1 - I + \frac{{ρ}^{2} - ( b , {b}^{gt} )}{{c}^{′ 2}} + \frac{{ρ}^{2} ( ω , {ω}^{gt} )}{{C}_{ω}^{2}} + \frac{{ρ}^{2} ( h , {h}^{gt} )}{{C}_{h}^{2}} ,$$

$$I = \frac{{A}_{gt} ⋂ {B}_{pr}}{{A}_{gt} ⋃ {B}_{pr}} ,$$

where
L_{EIOU} represents value of the loss function, b and b^{gt} respectively represent center points of a prediction box and a truth box; ρ represents an Euclidean distance between the two center points; c′ represents a diagonal distance of a smallest closure region that covers the prediction box and the truth box; ω^{gt} and h^{gt} respectively represent a length and width of the truth box; ω and h respectively represent a length and width of the prediction box; C_{ω} and Cₕ respectively represent a width and height of a smallest external box that covers the truth box and the prediction box; I represents an intersection of union of the prediction box and the truth box; A_{gt} represents an area of the truth box; and Bₚᵣ represents an area of the prediction box.

According to specific embodiments provided in the present disclosure, the present disclosure has the following technical effects:

According to the present disclosure, super-resolution reconstruction is performed through the USRNet on an image of the transmission line with poor quality and a complex background, to effectively enhance a contour feature of a target to be detected, and distinguish the target to be detected from the complex background. Therefore, the target to be detected is more easy to be detected by the detection model. Based on an original detection model, the detection head extracted for a small fault target of the transmission line includes a plurality of detected feature maps. Therefore, information about a small target in the shallow feature map is fully used, to improve detection accuracy of the small target. Due to use of a lightweight MobileNet backbone feature extraction network, a quantity of parameters of the model is reduced, calculations are reduced, and meet, to a certain extent, requirements for embedding a mobile device.

### BRIEF DESCRIPTION OF THE DRAWINGS

To describe the technical solutions in embodiments of the present disclosure or in the prior art more clearly, the accompanying drawings required in the embodiments are briefly described below. Apparently, the accompanying drawings in the following description show merely some embodiments of the present disclosure, and other drawings can be derived from these accompanying drawings by those of ordinary skill in the art without creative efforts.

FIG. 1 is a flowchart of a method for detecting an insulator fault of a transmission line based on a USRNet and an improved MobileNet-SSD algorithm according to a preferred embodiment of the present disclosure.

### DETAILED DESCRIPTION OF THE EMBODIMENTS

The technical solutions in the embodiments of the present disclosure are described clearly and in detail below with reference to the accompanying drawings in the embodiments of the present disclosure. The described embodiments are merely some rather than all of the embodiments of the present disclosure.

Due to fewer parameters, a fast speed, and strong robustness, a MobileNet backbone network is widely used in target detection in scenarios of various industries. In comparison with a YOLOv5x, the MobileNet-SSD detection model provided in the present disclosure has few parameters and low requirements for hardware. Therefore, the MobileNet-SSD detection model is more conducive to be deployed on mobile devices such as an unmanned aerial vehicle.

To resolve the above problem, the present disclosure provides a method for detecting an insulator fault based on preprocessing through a USRNet and an improved MobileNet-SSD, to accurately recognize an insulator target and detect a fault. This helps operation and maintenance personnel to grasp operating states of the transmission line, and guarantees safe operation of the transmission line to a specific extent.

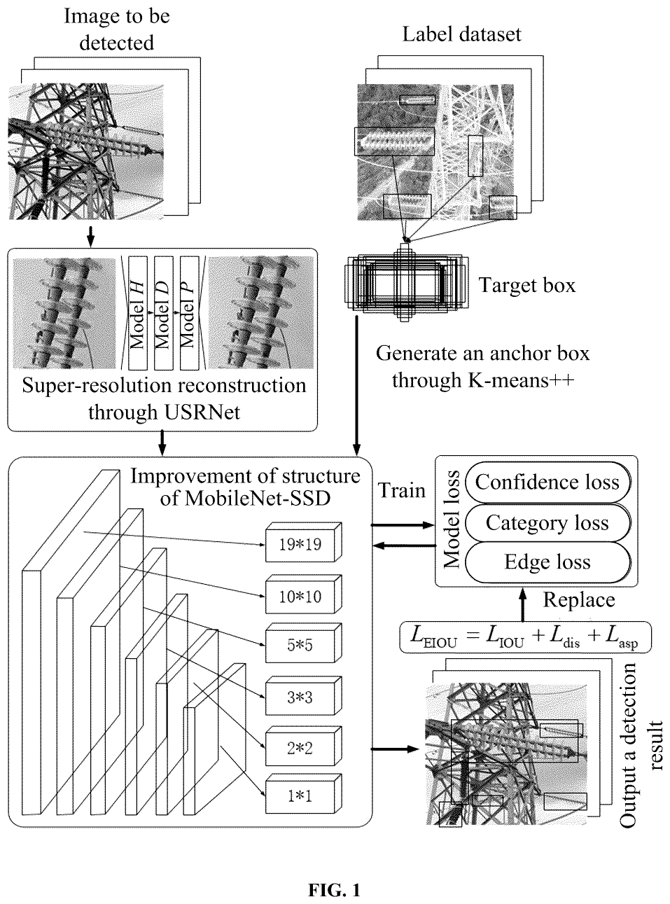

As shown in FIG. 1, a method for detecting an insulator fault of a transmission line based on a USRNet and an improved MobileNet-SSD algorithm includes the following steps.

(1) Improve quality of an image in a test set through a super-resolution image preprocessing technique based on a deep USRNet, to enhance a contour feature of a target to be detected and reduce interference of a complex background on target detection. Specifically, a total dataset of a transmission line is first acquired. The total dataset of the transmission line includes a plurality of test images, and each test image includes a labeled box of a target. Then, super-resolution reconstruction is performed on each test image based on the USRNet, to obtain an optimized image.

(2) Based on the labeled box of the target in the total dataset of the transmission line and a K-means++ clustering method, perform clustering to generate an anchor box, change a network structure of a MobileNet-SSD, add a detection head for detecting a small target, and perform adjustment through an edge loss function of the MobileNet-SSD detection model, to optimize overall performance.

(3) Recognize, by the MobileNet-SSD model improved in step (2), an insulator and a fault of the insulator from the image whose quality is improved in step (1).

Preferably, the improving quality of an image in a test set through a USRNet specifically includes: modeling a common problem of super-resolution:

$$k = arg {min}_{z} {‖ y - ( z ⊗ g ) {↓}_{s} ‖}^{2} + μ {σ}^{2} {‖ z - {x}_{k - 1} ‖}^{2} \qquad ( 1 )$$

$${x}_{k} = arg {min}_{z} \frac{μ}{2} {‖ {z}_{k} - x ‖}^{2} + λϕ ( x ) \qquad ( 2 )$$

x represents a high-resolution image of the transmission line; xₖ represents a high-resolution image of the transmission line when a k^{th} iteration is performed; xₖ₋₁ represents a high-resolution image of the transmission line when a (k−1)^{th} iteration is performed; z represents an auxiliary variable introduced based on a semi-quadratic splitting algorithm; zₖ represents an auxiliary variable introduced based on the semi-quadratic splitting algorithm when the k^{th} iteration is performed; g represents a fuzzy kernel; μ represents a penalty parameter for controlling a difference between z and x; k represents a quantity of iterations, k=1, . . . , 8; arg min represents a value of a subscript variable z when a posterior formula is smallest; s represents a multiple for bicubic subsampling; x and y represents a high-resolution (HR) image and a low-resolution (LR) image of the transmission line; ⊗ represents a symbol of a tensor product; ⬇ represents a subsampling operation; g represents a fuzzy kernel; ϕ(x) represents noise intensity; λ represents a hyperparameter for controlling the noise intensity; and σ represents a noise level. A clearest HR image x₈ of the transmission line may be obtained by solving x and z through iteration performed by a neural network.

Preferably, the USRNet is used to improve quality of the image in the test set, and the model is solved based on the neural network. A structure of the neural network mainly includes three parts.

A first part is a data module D, and is used to solve (1). The data module D performs fast Fourier transform F(·) and complex conjugate transform F⁻¹(·) through pytorch, introduces a hyperparameter αk, and minimized zₖ:

$${z}_{k} = {F}^{- 1} ( \frac{1}{{α}_{k}} ( d - \overline{F} ( g ) {⊙}_{s} \frac{( F ( g ) d ) {⇓}_{s}}{( \overline{F} ( g ) F ( g ) ) {⇓}_{s} + {α}_{k}} ) ) \qquad ( 3 )$$

F(·) represents a conjugate complex of F(·); αₖ represents a hyperparameter; F(g) represents Fourier transform performed on the fuzzy kernel; [symbol] represents a subsampler; and ⊙ represents an XNOR operator;

$$d = \overline{F} ( g ) F ( y {↑}_{s} ) + {α}_{k} F ( {x}_{k - 1} ) \qquad ( 4 )$$

⬆ represents an upsampling operation.

$${α}_{k} = μ k {σ}^{2} \qquad ( 5 )$$

The solution process is abbreviated as follows:

$${z}_{k} = D ( {x}_{k - 1} , s , g , y , {α}_{k} ) \qquad ( 6 )$$

When k=1, x₀ is obtained through y by nearest interpolation; and s represents a multiple of subsampling.

A second part is a prior module P, and is used to perform, through a U-shaped network added with a residual term, noise reduction on the original image, to solve (2), and the noise level is as follows:

$${β}_{k} = \sqrt{λ / {μ}_{k}} \qquad ( 7 )$$

βₖ represents a noise level when a k^{th} iteration is performed, μₖ represents a penalty parameter for controlling a difference between z and x when the k^{th} iteration is performed, and
the noise reduction process is abbreviated as follows:

$${x}_{k} = P ( {z}_{k} , {β}_{k} ) \qquad ( 8 )$$

A third part is a hyperparameter module H, and is used to calculate αₖ and βₖ required for each iteration:

$$[ α , β ] = H ( σ , s ) \qquad ( 9 )$$

In formula (9), α is αₖ, and β is βₖ, that is, a hyperparameter and a noise level during each iteration.

The hyperparameter module includes three fully connected layers, each layer has 64 hidden nodes, an activation function of the first two layers is ReLU, and an activation function of the last layer is Softplus.

Preferably, in step (2), based on the labeled box of the target in the total dataset of the transmission line and a K-means++ clustering method, the performing clustering to generate an anchor box specifically includes the following steps.

(21) Randomly take a target box of a sample as an initial clustering center, and calculate a minimum intersection over union (IOU) distance A(x′) between a remaining labeled box and a current clustering center:

$$A ( {x}^{} ) = 1 - {I}_{( {x}^{′} , c )} \qquad ( 10 )$$

I represents an intersection over union between the target boxes of two samples; x represents a labeled box of a sub-target sample, that is, one target box of a total target box, the labeled box of the sample is the labeled box of the target, and when a clustering algorithm is performed on the total target box, each target box is considered to be a sample; and C represents a clustering center.

(22) Calculate probability O(x′) that a target box of each insulator sample is taken as a next clustering center, and select the next clustering center through a roulette wheel method:

$$O ( {{x}^{′}}^{} ) = \frac{A {( {x}^{′} )}^{2}}{{\sum }_{{x}^{′} ∈ X} A {( {x}^{′} )}^{2}} \qquad ( 11 )$$

X represents a total sample of the labeled box of the target, that is, the total target box.

(23) Repeat step (21) and step (22) until K clustering centers are selected.

(24) Calculate a distance from each sample x′ in the total dataset of the transmission line to the K clustering centers, where the sample in the dataset is the high-resolution image of the transmission line, assign the sample to a category corresponding to a clustering center with a smallest distance, and recalculate a clustering center of each category cₗ as shown in formula (12); and re-update classification and the clustering center until the size of the anchor box remains unchanged:

$${c}_{l} = \frac{1}{\vert {c}_{l} \vert} {\sum }_{{x}^{′} ∈ {c}_{l}} {x}^{′} \qquad ( 12 )$$

l=1, . . . , K; K represents a quantity of different sizes of anchor boxes, and a value of K is determined by a quantity of anchor boxes in the MobileNet-SSD detection model.

Preferably, the constructed improved MobileNet-SSD detection model in step (2) is to add eight different scales of convolutional layers after a last convolutional layer of MobileNetV1, where a shallow feature layer is used to detect a small target object, and a deep feature layer is used to detect a large target object; and extract six different scales of effective feature maps from six of the layers through MobileNet-SSD, and perform multi-scale feature prediction, where resolutions of the effective feature maps are respectively 19*19, 10*10, 5*5, 3*3, 2*2, and 1*1.

Preferably, step (2) of performing adjustment through an edge loss function of the MobileNet-SSD detection model specifically includes the following steps.

Replace CIOU_Losses of the original model with effective intersection over union (EIOU)_Losses, where penalty terms of EIOU_Losses include an overlap loss L_{IOU}, a center distance loss L_{dis}, and a width-height loss Lₐₛₚ, and a calculation formula is as follows:

$${L}_{EIOU} = {L}_{IOU} + {L}_{dis} + {L}_{asp} = 1 - I + \frac{{ρ}^{2} - ( b , {b}^{gt} )}{{c}^{′ 2}} + \frac{{ρ}^{2} ( ω , {ω}^{gt} )}{{C}_{ω}^{2}} + \frac{{ρ}^{2} ( h , {h}^{gt} )}{{C}_{h}^{2}} \qquad ( 13 )$$

L_{EIOU} represents value of the loss function, b and b^{gt} respectively represent center points of a prediction box and a truth box; ρ represents an Euclidean distance between the two center points; c′ represents a diagonal distance of a smallest closure region that covers the prediction box and the truth box; ω^{gt} and h^{gt} respectively represent a length and width of the truth box; ω and h respectively represent a length and width of the prediction box; C_{ω} and Cₕ respectively represent a width and height of a smallest external box that covers the truth box and the prediction box; I represents an intersection of union of the prediction box and the truth box; A_{gt} represents an area of the truth box; and Bₚᵣ represents an area of the prediction box.

Preferably, the HR image obtained in step (1) is input to the MobileNet-SSD detection model obtained in step (2), to recognize an insulator on the HR image and detect a fault of the insulator. Through fault recognition, an insulator with faults such as self-explosion and missing of a ring may be recognized, and a damage location may be positioned.

Particular examples are used herein for illustration of principles and implementation modes of the present disclosure. The descriptions of the above embodiments are merely used for assisting in understanding the method of the present disclosure and its core ideas. In addition, those of ordinary skill in the art can make various modifications in terms of particular implementation modes and the scope of application in accordance with the ideas of the present disclosure. In conclusion, the content of the description shall not be construed as limitations to the present disclosure.

1. A method for detecting an insulator fault of a transmission line based on an unfolding super-resolution network (USRNet) and an improved MobileNet-SSD algorithm, comprising:
performing super-resolution reconstruction on an original image through a deep USRNet, to implement optimization of a test dataset;
based on a MobileNet-SSD detection model, performing clustering on a labeled box through K-means++, to generate an anchor box matching a target size of a fault of a transmission line; and changing a structure of a multi-scale feature fusion module, and introducing, at a prediction end, a detection head comprising a larger feature map, to detect a small fault target; and
optimizing overall performance of the model based on an effective intersection over union (EIOU)_Loss function; and performing, based on a constructed improved MobileNet-SSD detection model, insulator recognition, positioning, and fault detection on an optimized image.

2. The method for detecting an insulator fault of a transmission line based on a USRNet and an improved MobileNet-SSD algorithm according to claim 1, wherein the performing super-resolution reconstruction on an original image through a deep USRNet specifically comprises:
modelling a common problem of super-resolution:
$${z}_{k} = arg {min}_{z} {‖ y - ( z ⊙ g ) {↓}_{s} ‖}^{2} + {μσ}^{2} {‖ z - {x}_{k - 1} ‖}^{2} ,$$
$${x}_{k} = arg {min}_{z} \frac{μ}{2} {‖ {z}_{k} - x ‖}^{2} + λ ϕ ( x ) ,$$
wherein
x represents a high-resolution image of the transmission line; z represents an auxiliary variable introduced based on a semi-quadratic splitting algorithm; g represents a fuzzy kernel; μ represents a penalty parameter for controlling a difference between z and x; k represents a quantity of iterations, k=1, . . . , 8; arg min represents a value of a subscript variable z when a posterior formula is smallest; s represents a multiple for bicubic subsampling; y represents a low-resolution image of the transmission line; ⊗ represents a symbol of a tensor product; ⬇ represents a subsampling operation; ϕ(x) represents noise intensity; λ represents a hyperparameter for controlling the noise intensity; and σ represents a noise level; and
solving x and z through iteration of a neural network, to obtain a clearest high-resolution image x₈ of the transmission line.

3. The method for detecting an insulator fault of a transmission line based on a USRNet and an improved MobileNet-SSD algorithm according to claim 2, wherein a structure of the deep USRNet mainly comprises three parts;
a first part data module D, and is used to solve zₖ=arg min_{z}∥y−(z⊗g)⬇ₛ∥²+μσ²∥z−xₖ₋₁∥², and the data module D performs fast Fourier transform F(·) and complex conjugate transform F⁻¹(·) through pytorch, introduces a hyperparameter αₖ, and minimizes zₖ:
$${z}_{k} = {F}^{- 1} ( \frac{1}{{α}_{k}} ( d - \overline{F} ( g ) {⊙}_{s} \frac{( F ( g ) d ) {⇓}_{s}}{( \overline{F} ( g ) F ( g ) ) {⇓}_{s} + {α}_{k}} ) ) ,$$
wherein
F̅(·) represents a conjugate complex of F(·); αₖ represents a hyperparameter; F(g) represents Fourier transform performed on the fuzzy kernel; [symbol] represents a subsampler; ⊙ represents an XNOR operator; d=F̅(g)F(y ⬆_{z})+αₖF(xₖ₋₁), ⬆ represents an upsampling operation; and αₖ=μkσ²;
the solution process is abbreviated as follows:
$${z}_{k} = D ( {x}_{k - 1} , s , g , y , {α}_{k} ) ,$$
wherein
x₀ is obtained through y by nearest interpolation;
a second part is a prior module P, and is used to perform, through a U-shaped network added with a residual term, noise reduction on the original image, to solve
$${x}_{k} = arg {min}_{z} \frac{μ}{2} ‖ {z}_{k} - x {‖}^{2} + λϕ ( x ) ,$$
and the noise level is as follows:
$${β}_{k} = \sqrt{λ / {μ}_{k}} ,$$
wherein
the noise reduction process is abbreviated as follows:
$${x}_{k} = P ( {z}_{k} , {β}_{k} ) ;$$
and
a third part is a hyperparameter module H, and is used to calculate αₖ and βₖ required for each iteration:
$$[ α , β ] = H ( σ , s ) ,$$
wherein
the hyperparameter module comprises three fully connected layers, each layer has 64 hidden nodes, an activation function of the first two layers is ReLU, and an activation function of the last layer is Softplus.

4. The method for detecting an insulator fault of a transmission line based on a USRNet and an improved MobileNet-SSD algorithm according to claim 1, wherein the performing clustering on a labeled box through K-means++, to generate an anchor box matching a target size of a fault of a transmission line comprises:
randomly taking a target box of a sample as an initial clustering center, wherein the target box of the sample is the labeled box; and calculating a minimum intersection over union IOU distance A(x) between a remaining labeled box and a current clustering center:
$$A ( {x}^{′} ) = 1 - {I}_{( {x}^{′} , c )} ,$$
wherein
I represents an intersection over union between target boxes of two samples; x′ represents a labeled box of a sub-target sample; and c represents a clustering center;
calculating probability O(x′) that a target box of each insulator sample is taken as a next clustering center, and selecting the next clustering center through a roulette wheel method:
$$O ( {x}^{′} ) = \frac{A {( {x}^{′} )}^{2}}{{\sum }_{{x}^{′} ∈ X} A {( {x}^{′} )}^{2}} ,$$
wherein
X represents a total sample of the labeled box of the target;
repeating the foregoing steps until K clustering centers are selected;
calculating a distance from each sample x′ in the dataset to the K clustering centers, wherein the sample x′ in the dataset is the high-resolution image of the transmission line, assigning the sample x′ to a category corresponding to a clustering center with a smallest distance, and recalculating a clustering center of each category cₗ, wherein a formula is as follows; and re-updating classification and the clustering center until the size of the anchor box remains unchanged:
$${c}_{l} = \frac{1}{\vert {c}_{l} \vert} {\sum }_{{x}^{′} ∈ {c}_{l}} {x}^{′} ,$$
wherein
l=1, . . . , K; K represents a quantity of different sizes of anchor boxes, and a value of K is determined by a quantity of anchor boxes in the MobileNet-SSD detection model.

5. The method for detecting an insulator fault of a transmission line based on a USRNet and an improved MobileNet-SSD algorithm according to claim 1, wherein the constructed improved MobileNet-SSD detection model specifically comprises:
changing a structure of the MobileNet-SSD of the model, that is, adding eight different scales of convolutional layers after a last convolutional layer of MobileNetV1, wherein a shallow feature layer is used to detect a small target object, and a deep feature layer is used to detect a large target object; and extracting six different scales of effective feature maps from six of the layers through MobileNet-SSD, and performing multi-scale feature prediction, wherein resolutions of the effective feature maps are respectively 19*19, 10*10, 5*5, 3*3, 2*2, and 1*1.

6. The method for detecting an insulator fault of a transmission line based on a USRNet and an improved MobileNet-SSD algorithm according to claim 1, wherein the optimizing overall performance of the model based on an EIOU_Loss function specifically comprises:
replacing CIOU_Losses of the original model with EIOU_Losses, wherein penalty terms of EIOU_Losses comprise an overlap loss L_{IOU}, a center distance loss L_{dis}, and a width-height loss Lₐₛₚ, and a calculation formula is as follows:
$${L}_{EIOU} = {L}_{IOU} + {L}_{dis} + {L}_{asp} = 1 - I + \frac{{ρ}^{2} ( b , {b}^{gt} )}{{c}^{′ 2}} + \frac{{ρ}^{2} ( ω , {ω}^{gt} )}{{C}_{ω}^{2}} + \frac{{ρ}^{2} ( h , {h}^{gt} )}{{C}_{h}^{2}} ,$$
wherein
b and b^{gt} respectively represent center points of a prediction box and a truth box; ρ represents an Euclidean distance between the two center points; c′ represents a diagonal distance of a smallest closure region that covers the prediction box and the truth box; ω^{gt} and h^{gt} respectively represent a length and width of the truth box; ω and h respectively represent a length and width of the prediction box; and C_{ω} and Cₕ respectively represent a width and height of a smallest external box that covers the truth box and the prediction box.

7. The method for detecting an insulator fault of a transmission line based on a USRNet and an improved MobileNet-SSD algorithm according to claim 2, wherein the performing clustering on a labeled box through K-means++, to generate an anchor box matching a target size of a fault of a transmission line comprises:
randomly taking a target box of a sample as an initial clustering center, wherein the target box of the sample is the labeled box; and calculating a minimum intersection over union IOU distance A(x) between a remaining labeled box and a current clustering center:
$$A ( {x}^{′} ) = 1 - {I}_{( {x}^{′} , c )} ,$$
wherein
I represents an intersection over union between target boxes of two samples; x′ represents a labeled box of a sub-target sample; and c represents a clustering center;
calculating probability O(x′) that a target box of each insulator sample is taken as a next clustering center, and selecting the next clustering center through a roulette wheel method:
$$O ( {x}^{′} ) = \frac{A {( {x}^{′} )}^{2}}{{\sum }_{{x}^{′} ∈ X} A {( {x}^{′} )}^{2}} ,$$
wherein
X represents a total sample of the labeled box of the target;
repeating the foregoing steps until K clustering centers are selected;
calculating a distance from each sample x′ in the dataset to the K clustering centers, wherein the sample x′ in the dataset is the high-resolution image of the transmission line, assigning the sample x′ to a category corresponding to a clustering center with a smallest distance, and recalculating a clustering center of each category cₗ, wherein a formula is as follows; and re-updating classification and the clustering center until the size of the anchor box remains unchanged:
$${c}_{l} = \frac{1}{\vert {c}_{l} \vert} {\sum }_{{x}^{′} ∈ {c}_{l}} {x}^{′} ,$$
wherein
l=1, . . . , K; K represents a quantity of different sizes of anchor boxes, and a value of K is determined by a quantity of anchor boxes in the MobileNet-SSD detection model.

8. The method for detecting an insulator fault of a transmission line based on a USRNet and an improved MobileNet-SSD algorithm according to claim 2, wherein the optimizing overall performance of the model based on an EIOU_Loss function specifically comprises:
replacing CIOU_Losses of the original model with EIOU_Losses, wherein penalty terms of EIOU_Losses comprise an overlap loss L_{IOU}, a center distance loss L_{dis}, and a width-height loss Lₐₛₚ, and a calculation formula is as follows:
$${L}_{EIOU} = {L}_{IOU} + {L}_{dis} + {L}_{asp} = 1 - I + \frac{{ρ}^{2} ( b , {b}^{gt} )}{{c}^{′ 2}} + \frac{{ρ}^{2} ( ω , {ω}^{gt} )}{{C}_{ω}^{2}} + \frac{{ρ}^{2} ( h , {h}^{gt} )}{{C}_{h}^{2}} ,$$
wherein
b and b^{gt} respectively represent center points of a prediction box and a truth box; ρ represents an Euclidean distance between the two center points; c′ represents a diagonal distance of a smallest closure region that covers the prediction box and the truth box; ω^{gt} and h^{gt} respectively represent a length and width of the truth box; ω and h respectively represent a length and width of the prediction box; and C_{ω} and Cₕ respectively represent a width and height of a smallest external box that covers the truth box and the prediction box.
